(19) United States
(12) Patent Application Publication
(10) Pub. No.: US 2025/0027681 A1
(43) Pub. Date: Jan. 23, 2025

(54) HOT WATER SUPPLY DEVICE, CONTROL METHOD FOR SAME, AND WATER TREATMENT DEVICE

(71) Applicant: COWAY CO., LTD., Gongju-si (KR)

(72) Inventor: Hyoung Min MOON, Gongju-si (KR)

(73) Assignee: COWAY CO., LTD., Gongju-si (KR)

(21) Appl. No.: 18/258,300

(22) PCT Filed: Oct. 8, 2021
(86) PCT No.: PCT/KR2021/013867

§ 371 Date: Jun. 19, 2023

(30) Foreign Application Priority Data
Dec. 17, 2020 (KR) 10-2020-0176992

(51) Int. Cl. F24H 9/20; F24H 9/00

(52) U.S. Cl. CPC F24H 9/2007; F24H 9/0005

(57) ABSTRACT

A hot water supply device includes: a water purification filter which purifies raw water; a heating unit into which purified water that has been filtered in the water purification filter flows, and which generates pre-heated water by heating the purified water to a first pre-heating temperature, or generates hot water by heating the purified water or reserve water, which is stored pre-heated water, to a target temperature that is higher than the first pre-heating temperature; a pre-heating tank in which the pre-heated water is stored as reserve water; a flow switching unit which switches the direction of the flow between the heating unit and the pre-heating tank; and a control unit which controls the heating unit and the flow switching unit.

### CROSS-REFERENCE TO RELATED APPLICATION

This application claims priority to and the benefit of Korean Patent Application No. 10-2020-0176992, filed on Dec. 17, 2020, the disclosure of which is incorporated herein by reference in its entirety.

### BACKGROUND

### 1. Field of the Invention

The present invention relates to a hot water supply device, a control method thereof and a water treatment device, and more specifically to a hot water supply device, a control method thereof and a water treatment device that are capable of using electricity efficiently by reducing the heating time when hot water is dispensed by heating reserve water that is pre-heated and stored, and providing abundant hot water at a temperature desired by the user as the amount of hot water increases, by heating reserve water that is stored at a first pre-heating temperature to a target temperature when hot water is dispensed, after heating and storing purified water to a first pre-heating temperature.

### 2. Discussion of Related Art

In general, a water purifier generates purified water by removing contaminants from raw water through a water purification filter. In particular, such a water purifier is provided with an instantaneous heating module to supply hot water in the case of a direct water type without a buffer tank. The instantaneous heating module controls the heating temperature by the flow rate of the supplied purified water and the applied power. That is, in order to increase the heating temperature, it is necessary to increase the power or decrease the flow rate of purified water. In this case, since the power is determined within a certain range for each device, the temperature control of the direct water purifier largely depends on the flow rate of purified water. Therefore, in general, the flow rate of purified water flowing into the instantaneous heating module is reduced to heat the purified water to a target temperature. However, this leads to a decrease in the output amount of hot water, causing customer dissatisfaction.

The hybrid instantaneous hot water device including a pre-heating heater as disclosed in Japanese Registered Patent No. 2020-026943 of WATERSTAND Co., Ltd. is a method in which a plurality of heaters are selectively driven and additionally heat pre-heated water, and it supplies hot water at 90° C. or higher. Accordingly, since it is possible to quickly supply enough hot water at 90° C. or higher, the power required for heating can be lowered, and it can be operated stably. However, since it is necessary to provide an additional heater for pre-heating, there is a problem in that the manufacturing cost increases as well as the overall size of the hot water device increases or the structure becomes complicated.

### SUMMARY OF THE INVENTION

In order to solve the problems of the related art as described above, the hot water supply device, the control method thereof and the water treatment device according to the present invention are directed to using electricity efficiently by reducing the heating time when hot water is dispensed by heating reserve water that is pre-heated and stored, and providing abundant hot water at a temperature desired by the user as the amount of hot water increases, by heating reserve water that is stored at a first pre-heating temperature to a target temperature when hot water is dispensed, after heating and storing purified water to a first pre-heating temperature.

The hot water supply device, the control method thereof and the water treatment device according to an exemplary embodiment of the present invention are directed to reducing the overall size of the device or the manufacturing cost, by generating hot water by using a built-in heating unit without a separate pre-heater to prevent a decrease in the flow rate of hot water.

The hot water supply device, the control method thereof and the water treatment device according to an exemplary embodiment of the present invention are directed to improving user satisfaction, by increasing the output amount of hot water by dispensing reserve water if a drop in the temperature of reserve water is detected, and heating purified water to re-store reserve water that is heated to a first pre-heating temperature so as to maintain the temperature of reserve water at a constant temperature.

The hot water supply device, the control method thereof and the water treatment device according to an exemplary embodiment of the present invention are directed to ensuring the temperature reliability of reserve water, by having a temperature sensor that detects the temperature of reserve water to enable immediate response to the temperature change of reserve water.

The hot water supply device, the control method thereof and the water treatment device according to an exemplary embodiment of the present invention are directed to improving power efficiency, by repeating the discharge and re-storage of reserve water at regular time intervals so as to maintain a constant amount of power for heating to a target temperature in the heating unit.

The hot water supply device, the control method thereof and the water treatment device according to an exemplary embodiment of the present invention are directed to efficiently using resources by reducing unnecessary consumption of raw water by having a heater for heating the pre-heating tank to maintain a first pre-heating temperature so as to omit the processes of discharging and restoring reserve water.

The hot water supply device, the control method thereof and the water treatment device according to an exemplary embodiment of the present invention are directed to reducing power consumption, by providing a pre-heating tank with an insulating material or disposing an insulating material around an outer periphery of the pre-heating tank to minimize the reheating of a heating unit to replenish reserve water.

The hot water supply device, the control method thereof and the water treatment device according to an exemplary embodiment of the present invention are directed to automating the flow path configuration for each mode by controlling the flow switching unit and the heating unit to switch the flow path according to the pre-heating mode and the hot water dispensing mode.

However, the problems to be solved by the present invention are not limited to the above-mentioned problems, and other problems that are not mentioned will be clearly understood by those skilled in the art from the following description.

In order to solve the above-described problems, the hot water supply device according to the present invention may include a water purification filter which purifies raw water; a heating unit into which purified water that has been filtered in the water purification filter flows, and which generates pre-heated water by heating the purified water to a first pre-heating temperature, or generates hot water by heating the purified water or reserve water, which is stored pre-heated water, to a target temperature that is higher than the first pre-heating temperature; a pre-heating tank in which the pre-heated water is stored as reserve water; a flow switching unit which switches the direction of the flow between the heating unit and the pre-heating tank; and a control unit which controls the heating unit and the flow switching unit, wherein in the pre-heating mode, the control unit controls the heating unit to generate the pre-heated water by heating purified water flowing from the water purification filter to the heating unit to the first pre-heating temperature, and controls the flow switching unit such that the pre-heated water generated by the heating unit is transferred to the pre-heating tank, and wherein in the hot water dispensing mode, the control unit controls the flow switching unit such that the reserve water flows into the heating unit, and controls the heating unit to generate the hot water by heating the reserve water flowing from the pre-heating tank to the heating unit to the target temperature.

The hot water supply device according to an exemplary embodiment of the present invention may further include a temperature sensor which is provided in the pre-heating tank to detect the temperature of the reserve water, wherein when the temperature of the reserve water is less than or equal to a first pre-heating temperature, the control unit controls the heating unit to generate the pre-heated water by heating the purified water to the first pre-heating temperature, and controls the flow switching unit such that the pre-heated water generated by the heating unit flows into the pre-heating tank, and the reserve water stored in the pre-heating tank is discharged to the outside.

In the hot water supply device according to an exemplary embodiment of the present invention, the control unit may control the heating unit to generate the pre-heated water by heating the purified water to the first pre-heating temperature at each preset time; and the control unit may control the flow switching unit such that the pre-heated water generated in the heating unit flows into the pre-heating tank, and the reserve water stored in the pre-heating sink is discharged to the outside.

The hot water supply device according to an exemplary embodiment of the present invention may further include a heater which is provided along an outer periphery of the pre-heating tank, wherein the control unit controls the heater to heat the pre-heating tank in order to maintain the reserve water at the first pre-heating temperature.

In the hot water supply device according to an exemplary embodiment of the present invention, the control unit may control the heater to heat the pre-heating tank at regular time intervals or heat the pre-heating tank when the temperature of the reserve water is less than the first pre-heating temperature.

In the hot water supply device according to an exemplary embodiment of the present invention, the pre-heating tank may be made of an insulating material or an insulating material is disposed around the outer periphery.

In the hot water supply device according to an exemplary embodiment of the present invention, the pre-heating tank may be provided with a first opening and a second opening at upper ends, and a capillary tube which extends toward the bottom of the pre-heating tank may be provided in the second opening.

In the hot water supply device according to an exemplary embodiment of the present invention, in the pre-heating mode, the control unit may control the flow switching unit such that the pre-heated water flows into the pre-heating tank through the first opening, and the reserve water is discharged to the outside through the capillary tube and the second opening, and in the heating mode, the control unit may control the flow switching unit such that the purified water flows into the pre-heating tank through the capillary tube and the second opening, and the reserve water is discharged toward the heating unit through the first opening.

In the hot water supply device according to an exemplary embodiment of the present invention, the flow switching unit may include a first valve which is disposed on a first flow path from the side of the water purification filter toward the heating unit to open and close the first flow path such that the purified water flows into the heating unit; a second valve which is disposed on the input side of the heating unit to open and close a second flow path that is branched from the first flow path such that either the purified water or the reserve water flows into the heating unit; a third valve which is disposed on a third flow path from the output side of the heating unit toward the pre-heating tank to open and close the third flow path such that the pre-heated water flows into the pre-heating tank; a fourth valve which is disposed on a fourth flow path that is branched from the third flow path and coupled to the second flow path to open and close the fourth flow path such that either the purified water or the reserve water from the pre-heating tank flows into the heating unit; a fifth valve which is disposed on a fifth flow path leading to a drain valve for discharging the reserve water from the pre-heating tank to the outside to open and close the fifth flow path such that the reserve water is discharged to the drain valve; a sixth valve which is disposed on a sixth flow path from the side of the water purification filter toward the pre-heating tank to open and close the sixth flow path such that the purified water flows into the preheating tank; and an eighth valve which is disposed on an eighth flow path leading to an extraction valve for extracting one of the hot water or the purified water from the output side of the heating unit to open and close the eighth flow path such that the hot water is extracted to the extraction valve.

In the hot water supply device according to an exemplary embodiment of the present invention, the flow switching unit may further include a ninth valve which is disposed on a ninth flow path that is branched from the first flow path toward the extraction valve to open and close the ninth flow path such that the purified water is extracted through the extraction valve.

The hot water supply device according to an exemplary embodiment of the present invention may further include a seventh flow path which connects branching points of the third flow path and the fourth flow path from the pre-heating tank.

The water treatment device according to the present invention may include the above-described hot water supply device; and a housing in which the hot water supply device is embedded, wherein the pre-heating tank is provided at a plurality of locations where moisture is generated in the housing.

In the water treatment device according to an exemplary embodiment of the present invention, the pre-heating tank may be made of a thermally conductive material, and the control unit may control the heating unit to heat the purified water to a second pre-heating temperature that is higher than the first pre-heating temperature in order to remove moisture that is generated around the pre-heating tank by heat emitted from the pre-heating tank.

In the water treatment device according to an exemplary embodiment of the present invention, when the temperature of the reserve water stored in any one of the plurality of pre-heating tanks is less than or equal to the first preheating temperature, the control unit may control the heating unit to generate the pre-heated water by heating the purified water to the second preheating temperature, and the control unit may control the flow switching unit such that the pre-heated water generated in the heating unit flows into the corresponding pre-heating tank, and the reserve water stored in the corresponding pre-heating tank is discharged to the outside.

The method for supplying hot water according to the present invention may include the steps of supplying purified water filtered by a water purification filter to a heating unit by a flow switching unit; generating pre-heated water by heating the purified water to a first pre-heating temperature by the heating unit; supplying the generated pre-heated water to a pre-heating tank by the flow switching unit; storing the pre-heated water as reserve water by the pre-heating tank; determining, by a control unit, whether hot water is input; supplying the reserve water to the heating unit by the flow switching unit when hot water is input; generating hot water by heating the reserve water to a target temperature by the heating unit; and discharging the generated hot water to an extraction valve by the flow switching unit.

In the method for supplying hot water according to an exemplary embodiment of the present invention, the step of storing may further include the steps of determining, by the control unit, whether the temperature of the reserve water is less than or equal to a first pre-heating temperature or whether a preset time has elapsed; regenerating the pre-heated water by heating the purified water to the first pre-heating temperature by the heating unit, when the temperature of the reserve water is less than or equal to the first pre-heating temperature or a preset time has elapsed as a result of the determination; resupplying the regenerated pre-heated water to the pre-heating tank by the flow switching unit; and discharging the reserve water stored in the pre-heating tank to the outside by the flow switching unit.

In the method for supplying hot water according to an exemplary embodiment of the present invention, the step of storing may further include the step of heating the pre-heating tank by a heater that is provided along an outer periphery of the preheating tank such that the reserve water maintains the first pre-heating temperature.

The hot water supply device, the control method thereof and the water treatment device according to the present invention provide the effects of using electricity efficiently by reducing the heating time when hot water is dispensed by heating reserve water that is pre-heated and stored, and providing abundant hot water at a temperature desired by the user as the amount of hot water increases, by heating reserve water that is stored at a first pre-heating temperature to a target temperature when hot water is dispensed, after heating and storing purified water to a first pre-heating temperature.

The hot water supply device, the control method thereof and the water treatment device according to an exemplary embodiment of the present invention provide the effects of reducing the overall size of the device or the manufacturing cost, by generating hot water by using a built-in heating unit without a separate pre-heater to prevent a decrease in the flow rate of hot water.

The hot water supply device, the control method thereof and the water treatment device according to an exemplary embodiment of the present invention provide the effect of improving user satisfaction, by increasing the output amount of hot water by dispensing reserve water if a drop in the temperature of reserve water is detected, and heating purified water to re-store reserve water that is heated to a first pre-heating temperature so as to maintain the temperature of reserve water at a constant temperature.

The hot water supply device, the control method thereof and the water treatment device according to an exemplary embodiment of the present invention provide the effect of ensuring the temperature reliability of reserve water, by having a temperature sensor that detects the temperature of reserve water to enable immediate response to the temperature change of reserve water.

The hot water supply device, the control method thereof and the water treatment device according to an exemplary embodiment of the present invention provide the effect of improving power efficiency, by repeating the discharge and re-storage of reserve water at regular time intervals so as to maintain a constant amount of power for heating to a target temperature in the heating unit.

The hot water supply device, the control method thereof and the water treatment device according to an exemplary embodiment of the present invention provide the effect of efficiently using resources by reducing unnecessary consumption of raw water by having a heater for heating the pre-heating tank to maintain a first pre-heating temperature so as to omit the processes of discharging and restoring reserve water.

The hot water supply device, the control method thereof and the water treatment device according to an exemplary embodiment of the present invention provide the effect of reducing power consumption, by providing a pre-heating tank with an insulating material or disposing an insulating material around an outer periphery of the pre-heating tank to minimize the reheating of a heating unit to replenish reserve water.

The hot water supply device, the control method thereof and the water treatment device according to an exemplary embodiment of the present invention provide the effect of automating the flow path configuration for each mode by controlling the flow switching unit and the heating unit to switch the flow path according to the pre-heating mode and the hot water dispensing mode.

### BRIEF DESCRIPTION OF THE DRAWINGS

FIG. 1 is a block diagram of a hot water supply device according to the first example of the present invention.

FIG. 2 is a cross-sectional view of the first modified example of a pre-heating tank of the hot water supply device according to the first example of the present invention.

FIG. 3 is a cross-sectional view of the second modified example of a pre-heating tank of the hot water supply device according to the first example of the present invention.

FIG. 4 is a block diagram of a hot water supply device according to the first example of the present invention.

FIG. 5 is a flowchart of a method for supplying hot water according to the first example of the present invention.

FIG. 6 is a flowchart of a procedure for storing reserve water in the method for supplying hot water according to the first example of the present invention.

FIG. 7 is a block diagram showing the flow path configuration of a pre-heating mode of the method for supplying hot water according to the first example of the present invention.

FIG. 8 is a block diagram showing the flow path configuration of a hot water dispensing mode of the method for supplying hot water according to the first example of the present invention.

FIG. 9 is a block diagram of a water treatment device according to the second example of the present invention.

FIG. 10 is a block diagram of a water treatment device according to the second example of the present invention.

### DETAILED DESCRIPTION OF THE EMBODIMENTS

Hereinafter, with reference to the accompanying drawings, the exemplary embodiments of the present invention will be described in detail so that those of ordinary skill in the art can easily practice the present invention. The present invention may be embodied in many different forms and is not limited to the exemplary embodiments described herein. In order to clearly describe the present invention in the drawings, parts that are irrelevant to the description are omitted, and the same reference numerals are assigned to the same or similar components throughout the specification.

The exemplary embodiments of the present invention are provided to more completely explain the present invention to those of ordinary skill in the art, and the exemplary embodiments described below may be modified in various other forms, and the scope is not limited to the following examples. Rather, these examples are provided so that the present invention will be thorough and complete, and will fully convey the spirit of the invention to those skilled in the art.

Hereinafter, the exemplary embodiments of the present invention will be described with reference to drawings schematically illustrating examples of the present invention. In the drawings, variations of the illustrated shape may be expected, for example, depending on manufacturing technology and/or tolerances. Therefore, the exemplary embodiments of the present invention should not be construed as being limited to the specific shape of the region illustrated in the present specification, but should include, for example, a shape change caused by manufacturing.

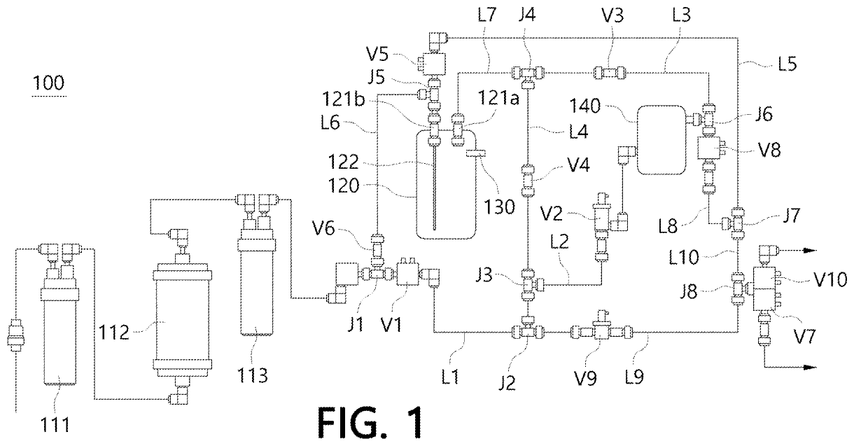

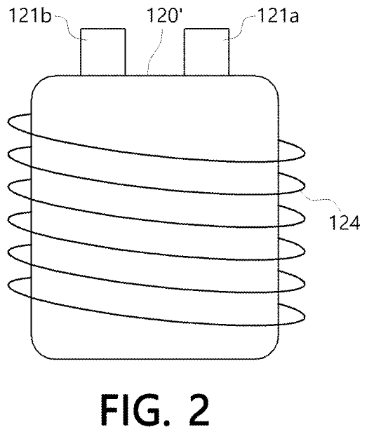

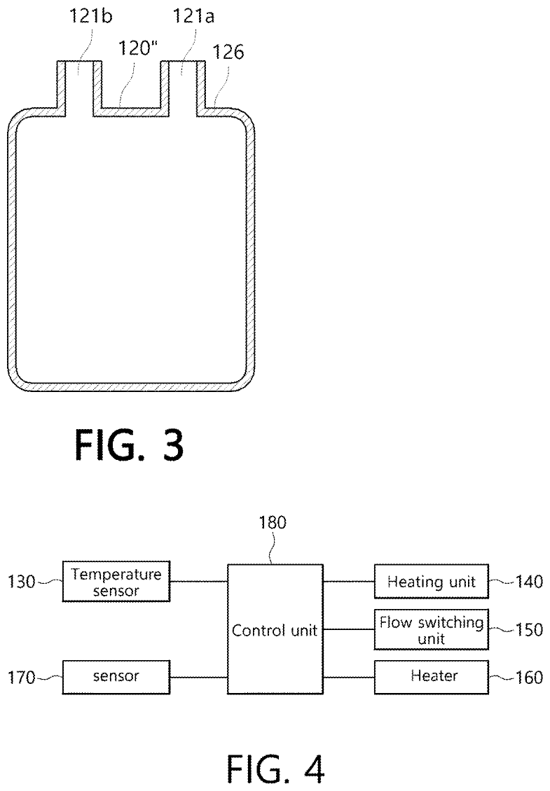

FIG. 1 is a block diagram of a hot water supply device according to the first example of the present invention, FIG. 2 is a cross-sectional view of the first modified example of a pre-heating tank of the hot water supply device according to the first example of the present invention, and FIG. 3 is a cross-sectional view of the second modified example of a pre-heating tank of the hot water supply device according to the first example of the present invention.

Referring to FIG. 1, the hot water supply device 100 according to the first example of the present invention may include water purification filters 111 to 113, a pre-heating tank 120, a temperature sensor 130, a heating unit 140 and valves V1 to V10.

The hot water supply device 100 according to the first example is a device for generating hot water by heating purified water or raw water to a target temperature, and it may be a water purifier, but the present invention is not particularly limited thereto. In addition, the hot water supply device 100 is not particularly limited to a direct water type or a tank type.

The water purification filters 111 to 113 may filter raw water that is supplied from the outside to generate purified water. The first filter 111 may be a pre-treatment filter for removing organic compounds and residual chlorine contained in raw water. The second filter 112 may be a filtration filter that filters raw water by the reverse osmosis (RO) method or the like. The third filter 113 may be a post-treatment filter for removing gas, odor, residual chlorine and the like.

The pre-heating tank 120 is provided with a first opening 121a and a second opening 121b at the upper ends, the first opening 121a may be connected to a seventh flow path L7, and the second opening 121b may be connected to a fifth branch point J5. Herein, the fifth branch point J5 branches into a fifth flow path L5 and a sixth flow path L6, and the seventh flow path L7 can connect between the first opening 121a and the fourth branch point J4. In this case, a capillary tube 122 which extends toward the bottom of the pre-heating tank 120 may be provided in the second opening 121b.

In the pre-heating tank 120, the pre-heated water that is heated by the heating unit 140 may be introduced into the first opening 121a through a third flow path L3 and a seventh flow path L7. Herein, the pre-heated water may be stored in the pre-heating tank 120 as reserve water. The third flow path L3 may connect between the sixth branch point J6 and the fourth branch point J4.

Further, in the pre-heating tank 120 in the hot water dispensing mode, purified water that is filtered by the water purification filters 111 to 113 may be introduced. In this case, the purified water flowing into the pre-heating tank 120 may flow into the lower side of the pre-heating tank 120 through the capillary tube 122. Herein, the purified water flowing into the pre-heating tank 120 may be heated by the heat of the reserve water or the internal heat of the pre-heating tank 120. Moreover, as the purified water flows into the lower side of the pre-heating tank 120, the reserve water that is stored in the pre-heating tank 120 may be discharged to the seventh flow path L7 through the first opening 121a, because it has a higher temperature than the purified water flowing into the pre-heating tank 120.

Referring to FIG. 2, the pre-heating tank 120′ may further include a heater 124 which is provided along the outer periphery. For example, the heater 124 may be a coil that is wound around the outer periphery of the pre-heating tank 120, but the present invention is not particularly limited thereto. In this case, the pre-heating tank 120′ may be made of a thermally conductive material and transfer the heat that is transferred from the heater 124 to the reserve water stored in the pre-heating tank 120. Therefore, the reserve water can be maintained at a constant temperature.

Accordingly, the hot water supply device 100 according to an exemplary embodiment of the present invention can omit the process of discharging and re-storing the reserve water for maintaining the reserve water at a constant temperature, because the reserve water can be maintained at a constant temperature, and therefore, it is possible to reduce the unnecessary consumption of raw water and use the resources efficiently.

Referring to FIG. 3, the pre-heating tank 120″ may have a thermal insulation case 126 that is disposed on the outer periphery. Optionally, the pre-heating tank 120″ may be made of an insulating material itself. In this case, the pre-heating tank 120 may block the heat of the reserve water stored therein from being discharged to the outside.

Accordingly, the hot water supply device 100 according to an exemplary embodiment of the present invention may reduce power consumption by minimizing the reheating of the heating unit 140 for replenishing the reserve water.

Referring back to FIG. 1, the temperature sensor 130 may be provided in the pre-heating tank 120 to detect the temperature of the reserve water. For example, the temperature sensor 130 may be provided at the upper end of the pre-heating tank 120, but the present invention is not particularly limited to the position thereof.

The heating unit 140 may have an input terminal connected to a second flow path L2 and an output terminal connected to a sixth branch point J6. Herein, the second flow path L2 may connect between the third branch point J3 and the heating unit 140. The sixth branch point J6 may branch into a third flow path L3 and an eighth flow path L8.

In the pre-heating mode, the heating unit 140 may generate pre-heated water by introducing purified water that is filtered by the water purification filters 111 to 113 and heating the purified water to a first pre-heating temperature. The heating unit 140 may generate hot water by heating the reserve water that is stored in the pre-heating tank 120 to a target temperature in the hot water dispensing mode. Herein, the target temperature may be higher than the first pre-heating temperature as the hot water outlet temperature. In this case, the heating unit 140 may generate hot water by heating the purified water flowing in from the pre-heating tank 120 to a target temperature after being replenished in the pre-heating tank 120. That is, the heating unit 140 may heat the reserve water that is stored in the pre-heating tank 120 first and then heat the purified water flowing in through the pre-heating tank 120.

Accordingly, since the hot water supply device 100 according to an exemplary embodiment of the present invention does not require a separate pre-heater to prevent a decrease in the flow rate of hot water, the entire hot water supply device 100 can be miniaturized or the manufacturing cost can be reduced.

Herein, the heating unit 140 and the valves V1 to V10 may be controlled by a control unit 180 as described below.

The first valve V1 may be disposed on the first flow path L1 from the side of the water purification filters 111 to 113 toward the heating unit 140 to open and close the first flow path L1 such that the purified water that is discharged from the water purification filters 111 to 113 flows into the heating unit 140. Herein, the first flow path L1 may connect between a first branch point J1 and a second branch point J2. In this case, the first valve V1 may be provided at one side of the first branch point J1. Herein, the first branch point J1 may branch into a first flow path L1 and a sixth flow path L6. The second branch point J2 may branch into a first flow path L1 and a ninth flow path L9.

The second valve V2 may be disposed on the second flow path L2 on the input side of the heating unit 140 to open and close the second flow path L2 such that either purified water or reserve water flows into the heating unit 140 via the third branch point J3. Herein, the third branch point J3 may branch into the second flow path L2 and the fourth flow path L4. The second valve V2 may be a flow control valve.

The third valve V3 may be disposed on the third flow path L3 from the output side of the heating unit 140 toward the pre-heating tank 120 to open and close the third flow path L3 such that the pre-heated water that is heated by the heating unit 140 flows into the pre-heating tank 120 via the fourth branch point J4. Herein, the fourth branch point J4 may branch into a seventh flow path L7 and a fourth flow path L4.

The fourth valve V4 may be disposed on the fourth flow path L4 from the pre-heating tank 120 toward the heating unit 140 to open and close the fourth flow path L4 such that one of purified water or reserve water flows from the pre-heating tank 120 flows into the heating unit 140. Herein, the fourth flow path L4 may connect between the fourth branch point J4 and the third branch point J3.

The fifth valve V5 may be disposed on the fifth flow path L5 towards the seventh valve V7 for discharging the reserve water from the pre-heating tank 120 to the outside to open and close the fifth flow path L5 such that the reserve water is discharged to the seventh valve V7 via the seventh branch point J7. Herein, the fifth flow path L5 may connect between a fifth valve V5 and a seventh branch point J7, and the seventh branch point J7 may branch into a fifth flow path L5 and an eighth flow path L8.

The sixth valve V6 may be disposed on the sixth flow path L6 from the side of the water purification filter 111 to 113 toward the pre-heating tank 120 to open and close the sixth flow path L6 such that the purified water flows to the pre-heating tank 120 via the first branch point J1. Herein, the sixth flow path L6 may connect between the first branch point J1 and the fifth branch point J5.

The seventh valve V7 may be disposed on one side of the eighth branch point J8 to open and close so as to discharge hot water through the eighth flow path L8, discharge purified water through the ninth flow path L9, or discharge reserve water through the fifth flow path L5. The seventh valve V7 may be a drain valve. The eighth branch point J8 may branch into a ninth flow path L9 and a tenth flow path L10. The tenth flow path L10 may connect between a seventh junction J7 and an eighth junction J8.

The eighth valve V8 may be disposed on the eighth flow path L8 toward the tenth valve V10 for extracting either hot water or purified water from the output side of the heating unit 140 to open and close the eight flow path L8 such that the hot water extracted to the tenth valve V10. The eighth flow path L8 may connect between an eighth valve V8 and a seventh branch point J7.

The ninth valve V9 may be disposed on the ninth flow path L9 that is branched from the first flow path L1 by the second branch point J2 toward the tenth valve V10 to open and close the ninth flow path L9 such that the purified water is extracted to the tenth valve V10. Herein, the ninth flow path L9 may connect between the second branch point J2 and the eighth branch point J8. The ninth valve V9 may be a water purification valve.

The tenth valve V10 may be disposed on one side of the eighth branch point J8 to open and close for the extraction of hot water through the eighth flow path L8 or the extraction of purified water through the ninth flow path L9. The tenth valve V10 may be an extraction valve.

FIG. 4 is a block diagram of a hot water supply device according to the first example of the present invention.

Referring to FIG. 4, the hot water supply device 100 according to the first example may further include a flow switching unit 150, a timer 170 and a control unit 180.

Herein, the heater 160 may be a heater 124 that is installed on the outer periphery of the pre-heating tank 120 as illustrated in FIG. 2.

The flow switching unit 150 is provided for switching the flow path direction between the heating unit 140 and the pre-heating tank 120, and it may include valves V1 to V10 as illustrated in FIG. 1. The flow switching unit 150 may operate according to the control of the control unit 180 to form any one path among purified water, pre-heated water and reserve water for each operation mode. Herein, in the pre-heating mode, the first valve V1 to the third valve V3 may be opened, and the fourth valve V4 to the tenth valve V10 may be blocked. In this case, when discharging the reserve water, the fifth valve V5 and the seventh valve V7 may be opened, and the first valve V1 to the fourth valve V4, the sixth valve V6 and the eighth valve V8 to the tenth valve V10 may be blocked. In the case of the hot water dispensing mode, the sixth valve V6, the fourth valve V4, the second valve V2, the eighth valve V8 and the tenth valve V10 may be opened, and the first valve V1, the third valve V3, the fifth valve V5, the seventh valve V7 and the ninth valve V9 may be blocked. Further, in the purified water dispensing mode, the first valve V1, the ninth valve V9 and the tenth valve V10 may be opened, and the second valve V2 to the eighth valve V8 may be blocked.

Accordingly, the hot water supply device 100 according to an exemplary embodiment of the present invention can automate the flow path configurations for pre-heating purified water and generating hot water by using the reserve water.

The timer 170 may provide time information for re-storing the reserve water of the pre-heating tank 120 or heating the pre-heating tank 120. For example, the timer 170 is built-in to the control unit 180 and may count the time that is set by the control unit 180.

The control unit 180 may be configured to control the operation of the temperature sensor 130, the heating unit 140 and the valves V1 to V10. Herein, the operation of the temperature sensor 130 means input to the control unit 180. The operation of the heating unit 140 means driving by the control unit 180. The operation of the valves V1 to V10 means opening and closing by the control unit 180. The control unit 180 may be a microprocessor that is built into the hot water supply device 100.

In the pre-heating mode, the control unit 180 may control the heating unit 140 to generate pre-heated water by heating the purified water flowing into the heating unit 140 from the water purification filters 111 to 113 to the first pre-heating temperature. In this case, the control unit 180 may control the flow switching unit 150 such that the purified water discharged from the water purification filters 111 to 113 flows into the heating unit 140, and the pre-heated water generated by the heating unit 140 flows into the pre-heating tank 120. Herein, the first pre-heating temperature is a pre-stage of the hot water outlet, and it may be lower than the target hot water temperature.

In the hot water dispensing mode, the control unit 180 may control the heating unit 140 to generate hot water by heating the reserve water flowing into the heating unit 140 from the pre-heating tank 120 to a target temperature. In this case, the control unit 180 may control the flow switching unit 150 such that the reserve water flows into the heating unit 140 from the pre-heating tank 120, and hot water generated in the heating unit 140 is discharged through the eighth flow path L8 and the tenth valve V10. For example, the target temperature may be 90° C. or higher.

As a result, the hot water supply device 100 according to an exemplary embodiment of the present invention uses the reserve water that is pre-heated to the first pre-heating temperature when heating for the hot water output such that the heating time is reduced by the reserve water that is pre-heated and stored, and thus, it is possible to use electricity efficiently, and the amount of hot water can be increased to provide abundant hot water at a user's desired temperature.

The control unit 180 may control to re-store the reserve water according to whether the temperature of the reserve water stored in the pre-heating tank 120 is lowered. Herein, the re-storage of the reserve water means storing new pre-heated water as reserve water in the pre-heating tank 120 and discharging the reserve water stored in the pre-heating tank 120 to the outside.

Accordingly, since the hot water supply device 100 according to an exemplary embodiment of the present invention can maintain the temperature of the reserve water stored in the pre-heating tank 120 at a constant temperature, it is not necessary to reduce the flow rate in the heating unit 140 when generating hot water, and therefore, it is possible to improve the satisfaction of the user by increasing the output amount of hot water.

For example, when the temperature of the reserve water is less than or equal to the first pre-heating temperature, the control unit 180 may control to re-store the reserve water. That is, when the temperature of the reserve water detected by the temperature sensor 130 is less than or equal to the first pre-heating temperature, the control unit 180 may control the heating unit 140 such that the purified water discharged from the water purification filters 111 to 113 is heated to a first pre-heating temperature to regenerate preheated water. In this case, the control unit 180 may control the flow switching unit 150 such that the purified water discharged from the water purification filters 111 to 113 flows into the heating unit 140, and the pre-heated water generated by the heating unit 140 flows into the pre-heating tank 120 as reserve water, and according to the inflow of new preheated water, the pre-stored reserve water is discharged from the preheating tank 120 to the outside.

As a result, the hot water supply device 100 according to an exemplary embodiment of the present invention can immediately respond to the temperature change of reserve water, thereby ensuring the temperature reliability of the stockpiling water, and thus, it is possible to ensure the reliability of preventing the reduction of the output amount of hot water.

As another example, the control unit 180 may control to re-store the reserve water at every preset time. That is, when the time preset in the timer 170 elapses, the control unit 180 may control the heating unit 140 to regenerate the pre-heated water by heating the purified water discharged from the water purification filters 111 to 113 to the first pre-heating temperature. In this case, the control unit 180 may control the flow switching unit 150 such that the purified water discharged from the water purification filters 111 to 113 flows into the heating unit 140, and the pre-heated water generated by the heating unit 140 flows into the pre-heating tank 120 as reserve water and the reserve water stored in the pre-heating tank 120 is discharged to the outside

As a result, the hot water supply device 100 according to an exemplary embodiment of the present invention can maintain a constant amount of power for heating to a target temperature in the heating unit 140 without using additional power due to a decrease in the temperature of the reserve water to improve power efficiency.

In this case, the control unit 180 may control the flow switching unit 150 to configure a flow path for the reserve water, pre-heated water or purified water for the pre-heating tank 120 for each operation mode.

For example, in the pre-heating mode, the control unit 180 may control the flow switching unit 150 such that the pre-heated water heated by the heating unit 140 flows into the pre-heating tank 120 through the first opening 121a. Herein, in the case of re-storing the reserve water, the control unit 180 may control the flow switching unit 150 such that the reserve water at below the first pre-heating temperature is discharged to the outside through the capillary tube 122 and the second opening 121b of the pre-heating tank 120.

In the hot water dispensing mode, the control unit 180 may control the flow switching unit 150 such that the reserve water stored in the pre-heating tank 120 is discharged toward the heating unit 140 through the first opening 121a. In this case, the control unit 180 may control the flow switching unit 150 such that purified water flows into the pre-heating tank 120 through the capillary tube 122 and the second opening 121b.

In the purified water output mode, the control unit 180 may control the flow switching unit 150 such that the purified water filtered by the water purification filters 111 to 113 is extracted to the outside through the tenth valve V10.

Meanwhile, the control unit 180 may control the pre-heating tank 120 to be maintained at the first pre-heating temperature. For example, when the heater 124 is provided on the outer periphery of the pre-heating tank 120, the control unit 180 may control the heater 124 to heat the pre-heating tank so maintain the reserve water stored in the pre-heating tank 120 at the first pre-heating temperature. In this case, the control unit 180 may control the heater 124 to heat the pre-heating tank 120, when the pre-heating tank 120 is heated at regular time intervals or the temperature of the reserve water detected by the temperature sensor 130 is lower than the first preheating temperature.

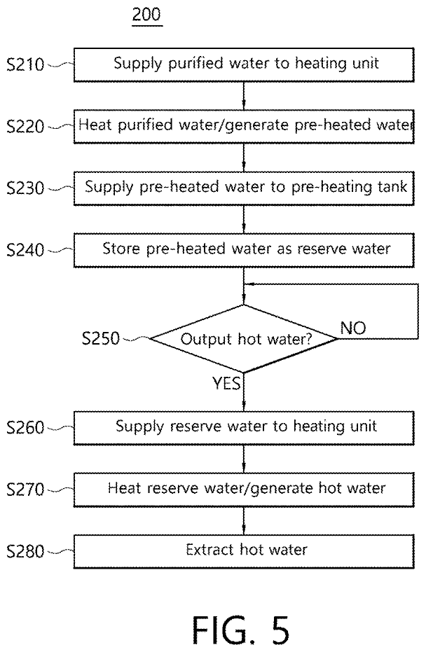

Hereinafter, the method for supplying hot water of the present invention will be described with reference to FIGS. 5 to 8.

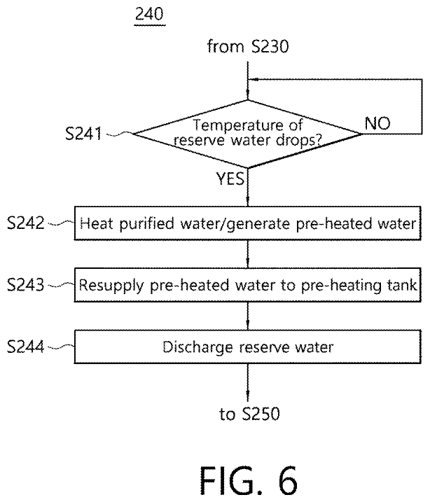

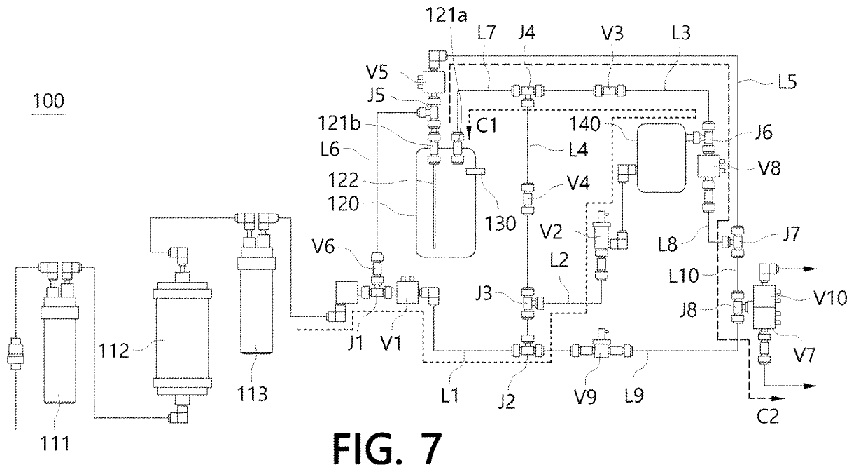

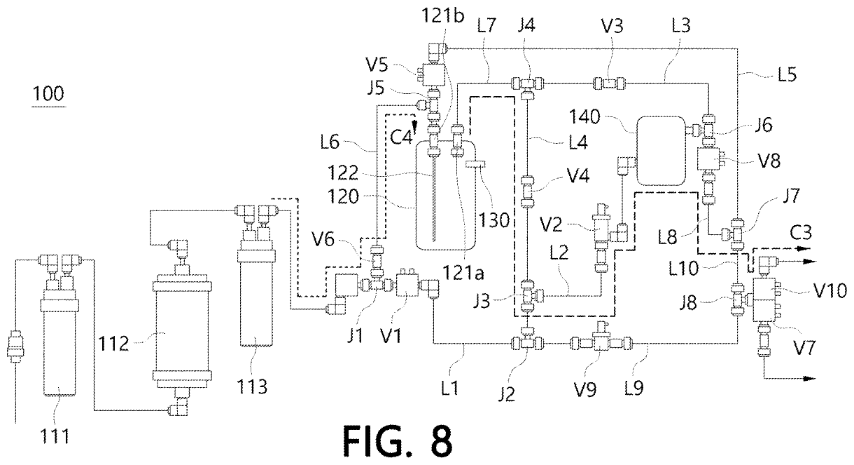

FIG. 5 is a flowchart of a method for supplying hot water according to the first example of the present invention, FIG. 6 is a flowchart of a procedure for storing reserve water in the method for supplying hot water according to the first example of the present invention, FIG. 7 is a block diagram showing the flow path configuration of a pre-heating mode of the method for supplying hot water according to the first example of the present invention, and FIG. 8 is a block diagram showing the flow path configuration of a hot water dispensing mode of the method for supplying hot water according to the first example of the present invention.

The method for supplying hot water 200 of the present invention includes the steps of generating pre-heated water by heating purified water S210 and S220, storing the pre-heated water as reserve water S230 and S240, and heating the reserve water when hot water is dispensed to provide hot water S250 to S280.

More specifically, as illustrated in FIG. 5, first of all, the flow switching unit 150 supplies the purified water filtered by the water purification filters 111 to 113 to the heating unit 140 (step S210). In this case, the flow switching unit 150 may configure a first path C1 of FIG. 7. That is, purified water filtered by the water purification filters 111 to 113 may be introduced into the heating unit 140 through the first flow path L1 and the second flow path L2.

Next, the heating unit 140 generates pre-heated water by heating the introduced purified water to the first pre-heating temperature (step S220). Herein, the first pre-heating temperature may be lower than the target temperature for generating hot water.

Next, the flow switching unit 150 supplies the pre-heated water generated by the heating unit 140 to the pre-heating tank 120 (step S230). In this case, the flow switching unit 150 may supply the pre-heated water to the pre-heating tank 120 through the first path C1 of FIG. 7. That is, the pre-heated water heated by the heating unit 140 may flow into the pre-heating tank 120 through the third flow path L3 and the seventh flow path L7.

Next, the pre-heating tank 120 stores the pre-heated water introduced from the heating unit 140 as reserve water (step S240). Herein, the pre-heated water introduced into the pre-heating tank 120 may be referred to as reserve water. In this case, as will be described below, the hot water supply device 100 may maintain the temperature of the reserve water stored in the pre-heating tank 120 at the first pre-heating temperature. For example, the heater 124 provided along the outer periphery of the pre-heating tank 120 may heat the pre-heating tank 120 such that the reserve water maintains the first pre-heating temperature.

Next, the control unit 180 determines whether hot water is input (step S250). In this case, the control unit 180 may determine whether hot water is input according to whether the tenth valve V10 is opened or closed or whether hot water is selected by a selection unit (not illustrated). As a result of the determination in step S250, if hot water is not input, it waits until hot water is input.

As a result of the determination in step S250, when hot water is input, the flow switching unit 150 supplies the reserve water stored in the pre-heating tank 120 to the heating unit 140 (step S260). In this case, the flow switching unit 150 may configure a third path C3 of FIG. 8. That is, the reserve water stored in the pre-heating tank 120 may be introduced into the heating unit 140 through the fourth flow path L4 and the second flow path L2.

At the same time, the flow switching unit 150 may configure a fourth path C4 of FIG. 8 such that purified water flows into the pre-heating tank 120. That is, purified water filtered by the water purification filters 111 to 113 may be introduced into the pre-heating tank 120 through the sixth flow path L6. Herein, purified water may be introduced into the lower side of the pre-heating tank 120 through the capillary tube 122 of the pre-heating tank 120. Accordingly, the reserve water having a higher temperature than the purified water introduced into the pre-heating tank 120 may be discharged to the seventh flow path L7 through the first opening 121a.

Next, the heating unit 140 generates hot water by heating the reserve water introduced from the pre-heating tank 120 to a target temperature (step S270). For example, the target temperature may be 90° C. or higher. In this case, when the heating of the reserve water is completed, the heating unit 140 may heat the purified water introduced from the pre-heating tank 120 following the reserve water.

Next, the flow switching unit 150 extracts hot water by discharging the hot water generated by the heating unit 140 through the tenth valve V10 (step S280). In this case, the flow switching unit 150 may discharge hot water through the third path C3 of FIG. 8. That is, the hot water generated by the heating unit 140 may be extracted to the tenth valve V10 through the eighth flow path L8 and the tenth flow path L10.

Meanwhile, the reserve water storing procedure 240 of the method for supplying hot water of the present invention may include the step S241 of detecting a drop in the reserve water temperature and the steps of discharging and re-storing the reserve water S243 to S243.

More specifically, as illustrated in FIG. 6, first of all, after the pre-heated water is supplied to the pre-heating tank 120 (step S230), the control unit 180 determines whether the temperature of the reserve water stored in the pre-heating tank 120 decreases (step S241). For example, the control unit 180 may determine whether the temperature of the reserve water detected by the temperature sensor 130 is less than or equal to the first pre-heating temperature. As another example, the control unit 180 may determine the temperature drop of the reserve water according to whether a preset time has elapsed.

As a result of the determination in step S241, when the temperature of the reserve water does not drop, the control unit 180 may continuously detect whether the temperature of the reserve water has decreased. Herein, the case when the temperature of the reserve water does not drop may be the case when the temperature of the reserve water detected by the temperature sensor 130 exceeds the first pre-heating temperature, or the case when a preset time has not elapsed.

As a result of the determination in step S241, when the temperature of the reserve water has dropped, the heating unit 140 regenerates the pre-heated water by heating the purified water to the first pre-heating temperature (step S242). Herein, the case when the temperature of the reserve water has dropped may be the case when the temperature of the reserve water detected by the temperature sensor 130 is less than or equal to the first pre-heating temperature, or the case when a preset time has elapsed.

In this case, the flow switching unit 150 may configure the first path C1 of FIG. 7. That is, purified water filtered by the water purification filters 111 to 113 may be re-supplied to the heating unit 140 through the first flow path L1 and the second flow path L2.

Next, the flow switching unit 150 re-supplies the pre-heated water regenerated by the heating unit 140 to the pre-heating tank 120 (step S243). Herein, the flow switching unit 150 may supply the pre-heated water to the pre-heating tank 120 through the first path C1 of FIG. 7. That is, the pre-heated water reheated by the heating unit 140 may be reintroduced into the pre-heating tank 120 through the third flow path L3 and the seventh flow path L7.

Next, the flow switching unit 150 discharges the reserve water stored in the pre-heating tank 120 to the outside (step S244). In this case, the flow switching unit 150 may configure a second path C2 of FIG. 7. That is, the reserve water whose temperature has decreased due to the inflow of new pre-heated water may be discharged to the seventh valve V7 through the fifth flow path L5 and the tenth flow path L10.

Next, the control unit 180 may proceed to step S250 to determine whether hot water is dispensed.

The above methods may be implemented by the hot water supply device 100 as illustrated in FIG. 1, and in particular, they may be implemented as software programs for performing these steps. In this case, these programs may be stored in a computer-readable recording medium or transmitted by computer data signals combined with a carrier wave in a transmission medium or communication network. In this case, the computer-readable recording medium may include any type of recording devices in which data readable by a computer system is stored.

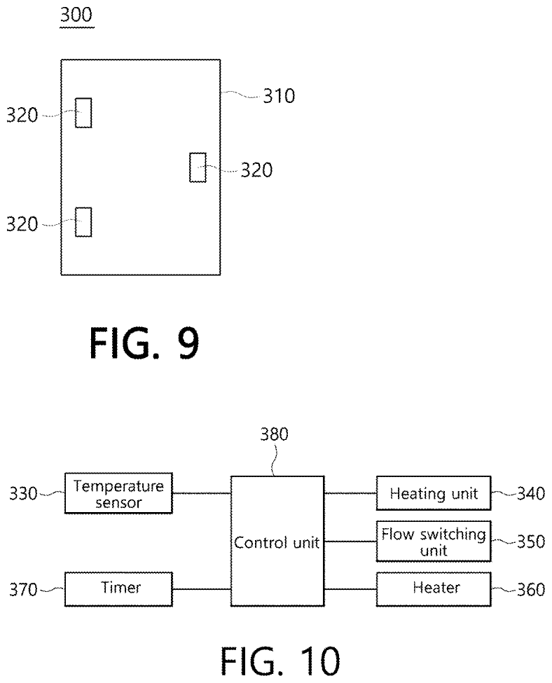

FIG. 9 is a block diagram of a water treatment device according to the second example of the present invention, and FIG. 10 is a block diagram of a water treatment device according to the second example of the present invention.

Referring to FIGS. 9 and 10, the water treatment device 300 according to the second example may include a housing 310, a pre-heating tank 320, a temperature sensor 330, a heating unit 340 and a flow switching unit 350, a heater 360, a timer 370 and a control unit 380. Herein, the water treatment device 300 according to the second example is provided with a plurality of pre-heating tanks 320, and since the configurations except for heating the purified water are the same as the hot water supply device 100 according to the first example, the detailed descriptions thereof will be omitted.

The water treatment device 300 according to the second example is provided for removing moisture generated in the housing 310 by using heat generated from the pre-heating tank 320, and it may be provided with a plurality of pre-heating tanks 320. Herein, the water treatment device 300 is not particularly limited to a water purifier.

The housing 310 may be an external case of the water treatment device 300. That is, the housing 310 may have a built-in hot water supply device 100 as shown in FIG. 1.

The pre-heating tank 320 may be provided at a plurality of positions where moisture is generated within the housing 310, respectively. Herein, the pre-heating tank 320 may be made of a thermally conductive material so as to have an excellent heating function by the reserve water. In this case, since a plurality of pre-heating tanks 320 are provided, the volume may be smaller than that of the pre-heating tank 120 of FIG. 1. For example, the pre-heating tank 320 may be provided to be relatively fine and thin according to the location where moisture is generated in the housing 310.

The control unit 380 may control the heating unit 340 to heat the purified water to a second pre-heating temperature higher than the first pre-heating temperature in order to remove moisture generated around the pre-heating tank 320 by the heat emitted from the pre-heating tank 320. That is, the reserve water stored in the pre-heating tank 320 must have a higher temperature than that of the pre-heating tank 120 of FIG. 1, because heat is dissipated to remove moisture in the housing 310.

In this case, when the temperature of the reserve water stored in any one of the plurality of pre-heating tanks 320 is less than or equal to the first pre-heating temperature, the control unit 380 may re-store the reserved water of the corresponding pre-heating tank 320. Herein, if the temperature of the reserve water stored in the pre-heating tank 320 is less than or equal to the first pre-heating temperature, it is not possible to sufficiently prevent the reduction of hot water due to heating by using the reserve water, and thus, the temperature of the reserve water stored in the pre-heating tank 320 is maintained at least at the first preheating temperature. That is, the control unit 180 may control the flow switching unit 150 such that the purified water filtered by the water purification filters 311 to 313 is re-introduced into the heating unit 340, and the reserve water stored in the pre-heating tank 320 is discharged to the outside. In addition, the control unit 180 may control the heating unit 340 such that the re-introduced purified water is heated to the second pre-heating temperature to generate preheated water, and control the flow switching unit 350 such that the pre-heated water generated by the heating unit 340 flows into the corresponding preheating tank 320.

Accordingly, since the water treatment device 300 according to an exemplary embodiment of the present invention can remove moisture in the housing 310 by utilizing the heat of the pre-heating tank 120 for storing the reserve water without having a separate heating means, it is possible to maintain performance and improve service lifespan. Moreover, since the water treatment device 300 is provided with a plurality of pre-heating tanks 120 to increase the capacity of the reserve water, it is possible to more effectively prevent the reduction in hot water output.

TABLE 1

Temperature of pre-heated water (° C.)

| | 20 | 40 | 50 | 60 |
|---|---|---|---|---|
| Hot water output | 0.47 | 0.65 | 0.82 | 1.08 |
| (LPM) | | | | |

The above table shows the output amount of hot water according to the temperature of pre-heated water. In this experiment, the target water output temperature was set to 90° C., and a heater having an output of 2,400 W was used as an instantaneous water heater. As illustrated in the table, when the temperature of the pre-heated water was 20° C., the hot water output was 0.47 LPM (liters per minute), but when the temperature of the pre-heated water was 60° C., the hot water output was 1.08 LPM (liters per minute), and thus, it was confirmed that the output amount was increased by 2.3 times. Therefore, it is possible to significantly increase the extraction amount of hot water by adding a pre-heating tank and maintaining an appropriate pre-heating water temperature.

Although an exemplary embodiment of the present invention has been described above, the spirit of the present invention is not limited to the exemplary embodiments presented herein, and those skilled in the art who understand the spirit of the present invention may easily suggest other exemplary embodiments by modifying, changing, deleting or adding components within the scope of the same spirit, but this will also be said to fall within the scope of the present invention.

Since the hot water supply device, the control method thereof and the water treatment device of the present invention can be implemented in various home appliances that are used at home or in an industrial field and a controller for controlling the same, they have industrial applicability.

1. A hot water supply device, comprising:
a water purification filter which purifies raw water;
a heating unit into which purified water that has been filtered in the water purification filter flows, and which generates pre-heated water by heating the purified water to a first pre-heating temperature, or generates hot water by heating the purified water or reserve water, which is stored pre-heated water, to a target temperature that is higher than the first pre-heating temperature;
a pre-heating tank in which the pre-heated water is stored as reserve water;
a flow switching unit which switches the direction of the flow between the heating unit and the pre-heating tank; and
a control unit which controls the heating unit and the flow switching unit,
wherein in the pre-heating mode, the control unit controls the heating unit to generate the pre-heated water by heating purified water flowing from the water purification filter to the heating unit to the first pre-heating temperature, and controls the flow switching unit such that the pre-heated water generated by the heating unit is transferred to the pre-heating tank, and
wherein in the hot water dispensing mode, the control unit controls the flow switching unit such that the reserve water flows into the heating unit, and controls the heating unit to generate the hot water by heating the reserve water flowing from the pre-heating tank to the heating unit to the target temperature.

2. The hot water supply device of claim 1, further comprising:
a temperature sensor which is provided in the pre-heating tank to detect the temperature of the reserve water,
wherein when the temperature of the reserve water is less than or equal to a first pre-heating temperature, the control unit controls the heating unit to generate the pre-heated water by heating the purified water to the first pre-heating temperature, and controls the flow switching unit such that the pre-heated water generated by the heating unit flows into the pre-heating tank, and the reserve water stored in the pre-heating tank is discharged to the outside.

3. The hot water supply device of claim 1, wherein the control unit controls the heating unit to generate the pre-heated water by heating the purified water to the first pre-heating temperature at each preset time; and the control unit controls the flow switching unit such that the pre-heated water generated in the heating unit flows into the pre-heating tank, and the reserve water stored in the pre-heating sink is discharged to the outside.

4. The hot water supply device of claim 1, further comprising:
a heater which is provided along an outer periphery of the pre-heating tank,
wherein the control unit controls the heater to heat the pre-heating tank in order to maintain the reserve water at the first pre-heating temperature.

5. The hot water supply device of claim 4, wherein the control unit controls the heater to heat the pre-heating tank at regular time intervals or heat the pre-heating tank when the temperature of the reserve water is less than the first pre-heating temperature.

6. The hot water supply device of claim 1, wherein the pre-heating tank is made of an insulating material or an insulating material is disposed around the outer periphery.

7. The hot water supply device of claim 1, wherein the pre-heating tank is provided with a first opening and a second opening at upper ends, and
wherein a capillary tube which extends toward the bottom of the pre-heating tank is provided in the second opening.

8. The hot water supply device of claim 7, wherein in the pre-heating mode, the control unit controls the flow switching unit such that the pre-heated water flows into the pre-heating tank through the first opening, and the reserve water is discharged to the outside through the capillary tube and the second opening, and in the heating mode, the control unit controls the flow switching unit such that the purified water flows into the pre-heating tank through the capillary tube and the second opening, and the reserve water is discharged toward the heating unit through the first opening.

9. The hot water supply device of claim 1, wherein the flow switching unit comprises:
a first valve which is disposed on a first flow path from the side of the water purification filter toward the heating unit to open and close the first flow path such that the purified water flows into the heating unit;
a second valve which is disposed on the input side of the heating unit to open and close a second flow path that is branched from the first flow path such that either the purified water or the reserve water flows into the heating unit;
a third valve which is disposed on a third flow path from the output side of the heating unit toward the pre-heating tank to open and close the third flow path such that the pre-heated water flows into the pre-heating tank;
a fourth valve which is disposed on a fourth flow path that is branched from the third flow path and coupled to the second flow path to open and close the fourth flow path such that either the purified water or the reserve water from the pre-heating tank flows into the heating unit;
a fifth valve which is disposed on a fifth flow path leading to a drain valve for discharging the reserve water from the pre-heating tank to the outside to open and close the fifth flow path such that the reserve water is discharged to the drain valve;
a sixth valve which is disposed on a sixth flow path from the side of the water purification filter toward the pre-heating tank to open and close the sixth flow path such that the purified water flows into the preheating tank; and
an eighth valve which is disposed on an eighth flow path leading to an extraction valve for extracting one of the hot water or the purified water from the output side of the heating unit to open and close the eighth flow path such that the hot water is extracted to the extraction valve.

10. The hot water supply device of claim 9, wherein the flow switching unit further comprises a ninth valve which is disposed on a ninth flow path that is branched from the first flow path toward the extraction valve to open and close the ninth flow path such that the purified water is extracted through the extraction valve.

11. The hot water supply device of claim 10, further comprising:
a seventh flow path which connects branching points of the third flow path and the fourth flow path from the pre-heating tank.

12. A water treatment device, comprising:
the hot water supply device according to claim 1; and
a housing in which the hot water supply device is embedded,
wherein the pre-heating tank is provided at a plurality of locations where moisture is generated in the housing.

13. The water treatment device of claim 12, wherein the pre-heating tank is made of a thermally conductive material, and
wherein the control unit controls the heating unit to heat the purified water to a second pre-heating temperature that is higher than the first pre-heating temperature in order to remove moisture that is generated around the pre-heating tank by heat emitted from the pre-heating tank.

14. The water treatment device of claim 13, wherein when the temperature of the reserve water stored in any one of the plurality of pre-heating tanks is less than or equal to the first preheating temperature, the control unit controls the heating unit to generate the pre-heated water by heating the purified water to the second preheating temperature, and the control unit controls the flow switching unit such that the pre-heated water generated in the heating unit flows into the corresponding pre-heating tank, and the reserve water stored in the corresponding pre-heating tank is discharged to the outside.

15. A method for supplying hot water, comprising the steps of:
supplying purified water filtered by a water purification filter to a heating unit by a flow switching unit;
generating pre-heated water by heating the purified water to a first pre-heating temperature by the heating unit;
supplying the generated pre-heated water to a pre-heating tank by the flow switching unit;
storing the pre-heated water as reserve water by the pre-heating tank;
determining, by a control unit, whether hot water is input;
supplying the reserve water to the heating unit by the flow switching unit when hot water is input;
generating hot water by heating the reserve water to a target temperature by the heating unit; and
discharging the generated hot water to an extraction valve by the flow switching unit.

16. The method of claim 15, wherein the step of storing further comprises the steps of:
determining, by the control unit, whether the temperature of the reserve water is less than or equal to a first pre-heating temperature or whether a preset time has elapsed;
regenerating the pre-heated water by heating the purified water to the first pre-heating temperature by the heating unit, when the temperature of the reserve water is less than or equal to the first pre-heating temperature or a preset time has elapsed as a result of the determination;
resupplying the regenerated pre-heated water to the pre-heating tank by the flow switching unit; and
discharging the reserve water stored in the pre-heating tank to the outside by the flow switching unit.

17. The method of claim 15, wherein the step of storing further comprises the step of:
heating the pre-heating tank by a heater that is provided along an outer periphery of the preheating tank such that the reserve water maintains the first pre-heating temperature.
